(19) United States
(12) Patent Application Publication
(10) Pub. No.: US 2012/0029950 A1
(43) Pub. Date: Feb. 2, 2012

(54) Systems And Methods For Health Insurance Claim Processing

(76) Inventors: James G. Lyle, Overland Park, KS (US); Alan Schif, Bonner Springs, KS (US)

(21) Appl. No.: 13/193,132

(22) Filed: Jul. 28, 2011

Related U.S. Application Data
(60) Provisional application No. 61/368,458, filed on Jul. 28, 2010.

(51) Int. Cl. G06Q 40/00

(52) U.S. Cl. 705/4

(57) ABSTRACT

A method of processing health insurance claims includes receiving, within a claim receiver, a claim submission from a client, the claim submission identifying a policy of the client and details of the health insurance claim. The claim receiver converts, within the claim receiver, the claim submission into a claim charge to facilitate automated processing of the health insurance claim. The claim charge is validated against one or more validation rules to the identify zero, one, or more claim validation exceptions. The validation exceptions are resolved and the claim submission is settled if the validated claim charge and any remaining validation exceptions conform to settlement control data.

### RELATED APPLICATIONS

This application claims priority to U.S. Patent Application Ser. No. 61/368,458 filed Jul. 28, 2010, which is incorporated herein by reference.

### BACKGROUND

It has been estimated that more than 6 billion insurance claims are filed in the United States each year, which works out to about 500 million claims per month. Of these claims, claims to US Medicare account for about 500 million claims per year. Outside of outpatient pharmacy claims, very few health claims are processed in real-time, and a large portion of the claims require human intervention to determine provider reimbursement based on the health plan's benefit structure.

The Health Insurance Portability and Accountability Act (HIPAA) was enacted by the U.S. Congress in 1996, which mandates that claims from certain qualifying entities must be submitted electronically. HIPAA also mandates the format of the electronic claim submissions. Uniform formatting helps everyone. However, even when claims are submitted electronically, conventional processing techniques still result in lengthy claim processing times from claim adjudication requirements. Electronic claim submission is more efficient to handle by both the health care provider and the insurance company. For example, Medicare pays two weeks faster for claims submitted electronically. The electronic claims submission process eliminates most of the claim entry effort and thereby reduces payment cycle times, but the electronic submission process has minimal impact on the claim adjudication portion of the cycle.

Non-electronic, paper healthcare claims are submitted to a claim payer using the format specified by U.S. Department of Health and Services Centers for Medicare & Medicaid Services (CMS). Physicians use the form CMS-1500 and institutions use the form CMS-1450. HIPAA specifies two electronic file formats as well; 837-Professional for physicians and 837-Institutional for institutions. In all cases, the design of the file formats is in master-detail format, where there is general invoice information that pertains to the entire episode of healthcare, and then itemized detail of each service provided. The insurance industry normally calls the master part of the invoice a “claim charge,” and the detail portion “service lines.”

In both HIPAA file formats and CMS forms, the healthcare provided is described using a standard set of industry standard codes. The codes can be of the following types:

ICD-9-CM diagnoses from the International Statistical Classification of Diseases and Related Health Problems.

CPT-4 (Current Procedural Terminology) from the American Medical Association.

HCPCS (Health Care Procedure Coding System) from the U.S. Department of Health and Services Centers for Medicare & Medicaid Services.

POS (place of service codes) from the U.S. Department of Health and Services Centers for Medicare & Medicaid Services.

NDC (National Drug Code) from the U.S. Drug Enforcement Administration (DEA).

DRG (Diagnosis Related Groups) from the U.S. Department of Health and Services Centers for Medicare & Medicaid Services.

Revenue, Value, Condition, and Occurrence Codes from the U.S. National Uniform Billing Committee.

ASC (Ambulatory Surgical Center Base Code) from the U.S. Department of Health and Services Centers for Medicare & Medicaid Services.

CDT-4 (Current Dental Terminology) from the American Dental Association.

FIG. 1 shows a block diagram illustrating a conventional claim process 100 within an insurance company 102. Company 102 has two claim analysts 104, 106, and each has a work queue 108, 110, respectively. The insurance company has three clients, client 1, client 2, and client 3 that each submits a claim form (claim form 1, claim form 2 and claim form 3, respectively). Typically, each claim form received by the company is added to the analyst's work queue 108, 110. Where the claim involves many different skills, the analyst 104, 106 may need to consult policy documentation and/or governmental regulations, or refer the claim to other company workers to resolve specific issues within the claim. An analyst may also require that certain information be supplied by the client, the medical care provider, or an external consultant. For example, the claim charge resulting from claim form 1 submitted by client 1 is validated against the insurance policy 1 to identify coverage under the policy. Since each client may have a different policy, and each claim may be different, the analyst processes each claim, evaluating each service line within the claim against the benefits as defined by the insurance policy and specific state and federal regulations to determine the amount of benefit. The analyst may require that information request 1 be supplied by client 1 in order to properly identify the appropriate benefit. Once the benefit has been determined by the analyst, client 1 receives benefit advice 1 which may include payment for the service.

Since each claim is assigned to one analyst at a time, the progress of the claim is dependent upon the skill or knowledge set and availability of that analyst. If a claim requires more than one kind of work due to validation exceptions or investigations, then either a single claim analyst must have the skills to perform all of the work or the work is performed sequentially by multiple analysts. This situation is especially true when document images that can be shared do not exist. If the analyst is absent from work (e.g., through illness or vacation), progress of the claim processing may stop. Where the claim is then assigned to a second analyst, the progress can still be delayed since processing of the claim then waits its turn within the second analyst's work queue. Claim analysts can often be assigned to process only a portion of the claims received by the health plan based on the following characteristics: Policy, State, Employer Group, analyst skill level, submission form type, or whether certain investigations are required. Traditionally, healthcare claim systems require the analyst to identify what steps are required to settle a claim. This identification process may include identifying what exceptions are present or what investigations may be required, as well as what benefits are applicable to the claim. This method of processing thus increases the chance that a claim may be settled in error, and it introduces inconsistencies of processing techniques from one analyst to another. Furthermore, some healthcare claim systems allow the analyst to directly control the financial results of the claim, which can result in settlements in excess of policy limits as well as introducing an opportunity for fraud.

### SUMMARY OF THE INVENTION

In one embodiment, a method processes a health insurance claim. A claim receiver receives, from a client, a claim submission that identifies a policy of the client and includes details of the health insurance claim. The claim receiver converts the claim submission into a claim charge to facilitate automated processing of the health insurance claim. The claim charge is validated against one or more validation rules to identify zero, one, or more claim validation exceptions and the claim validation exceptions are resolved. The claim submission is settled based upon the claim charge if the validated claim charge and any remaining validation exceptions conform to settlement control data.

In another embodiment, a software product has instructions, stored on a non-transient computer-readable medium, wherein the instructions, when executed by a computer, perform steps for health insurance claim processing, including the steps of: receiving a claim; converting the claim to a claim charge; validating the claim charge to identify claim validation exceptions; resolving the claim validation exceptions; and settling the claim.

In another embodiment, a health insurance claim processing system includes a database for storing tables and procedures that have machine readable instructions for providing: a claim format process for processing a claim submission received from a client into a claim charge; a claim validation process for validating the claim charge and generating zero, one or more validation exceptions; an exception resolution process for resolving the one or more validation exceptions; and a claim settlement process for settling the claim charge once all validation exceptions, if any, are resolved.

In another embodiment, a health insurance claim processing method, includes the steps of: formatting a plurality of claim submissions into a plurality of claim charges stored in an electronic database; determining at least one validation exception for each of the plurality of claim charges; grouping the at least one validation exception for each of the plurality of claim charges together with other validation exceptions of the same type from different ones of the plurality of claim charges to form a group of validation exceptions within the database; processing the group of validation exceptions together; and updating each of the plurality of claim charges with a respective processed validation exception.

### BRIEF DESCRIPTION OF THE FIGURES

FIG. 1 shows one prior art system for claim processing.

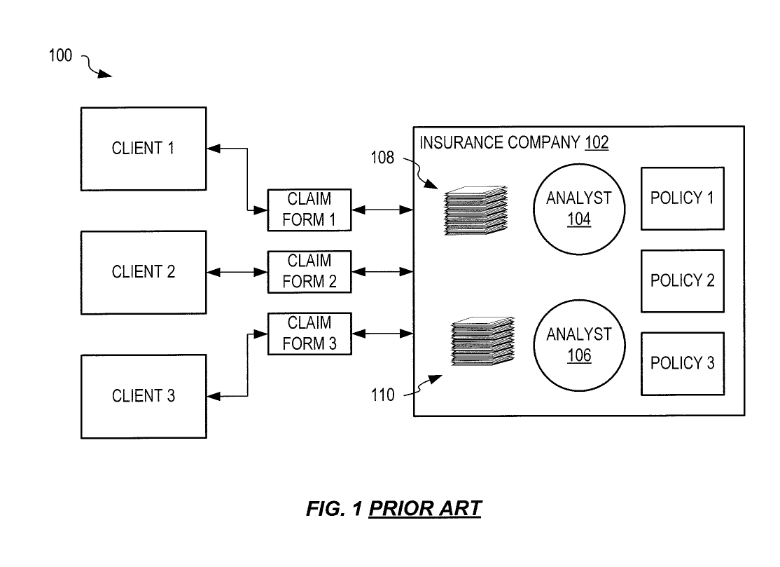

FIG. 2 shows an exemplary system embodiment for health insurance claim processing.

FIG. 3 shows the claim validation process of FIG. 2 in further detail.

FIG. 4 shows an exemplary claim format process of an embodiment.

FIG. 5 shows automatic action processing and identification of manual claim validation exception by the exception resolution process of FIG. 2.

FIG. 6 shows exemplary processing of claim validation exceptions by the exception resolution process of FIG. 2 and an analyst.

FIG. 7 shows exemplary settlement of a claim charge by the claim settlement process of FIG. 2.

### DETAILED DESCRIPTION OF THE FIGURES

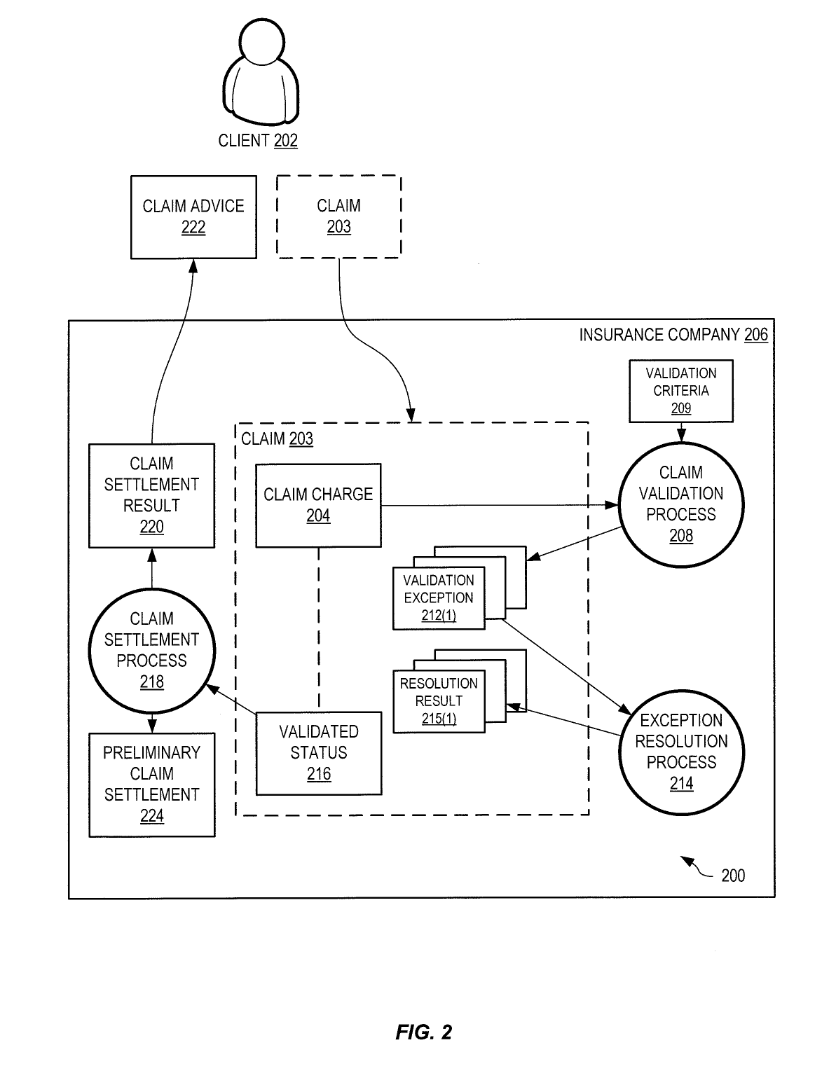

FIG. 2 shows an exemplary system 200 for health insurance claim processing. System 200 is, for example, implemented as a database application. System 200 includes a claim validation process 208, an exception resolution process 214, and a claim settlement process 218. In FIG. 2, a claim 203 is submitted by a client 202 to an insurance company 206. Insurance company 206 uses system 200 to evaluate and settle claim 203. Within system 200, claim 203 is stored as a claim charge 204. Claim validation process 208 determines if claim charge 204 meets all validation criteria 209 that are required for claim charge 204 to reach a validated status 216. Validated status 216 is, for example, a flag associated with claim charge 204.

If one or more of validation criteria 209 are not met by claim charge 204 then claim validation process 208 creates one or more validation exceptions 212 that require resolution prior to claim charge 204 reaching validated status 216. If no validation exceptions 212 exist for claim charge 204, then claim charge 204 has reached validated status 216. Validation exceptions 212 are processed by exception resolution process 214, and one or more resolution results 215 may be generated; resolution results 215 contain information determined during resolution of validation exceptions 212. Once all validations exceptions 212 are resolved for claim charge 204, claim charge 204 is considered to have reached validated status 216.

Many validation exceptions 212 may be processed simultaneously (e.g., by claim examination staff of insurance company 206). However, where one exception validation 212 influences resolution of another exception validation 212 and/or where resolution of one validation exception 212 creates one or more additional validation exceptions 212, processing of validation exceptions 212 may become sequential within system 200.

Once associated validation exceptions 212 of claim charge 204 are resolved, claim settlement process 218 settles claim charge 204. To settle claim charge 204, claim settlement process 218 considers claim charge 204 and resolution results 215 and then generates a claim settlement result 220 for delivery to client 202 as a claim advice 222.

In certain circumstances (e.g., where governmental regulations and/or contractual agreements require that a claim be initially settled within a specific time-frame, whether or not all validation exceptions are resolved), it may become necessary to settle claim charge 204 before all validation exceptions 212 are resolved. In this case, claim settlement process 218 generates a preliminarily settlement 224 for claim charge 204 using available resolution results 215 and ignoring any pending validation exceptions 212. This preliminary settlement 224 may result in either a payment or a denial being sent to client 202 within claim advice 222. When all pending validation exceptions 212 are resolved, claim settlement process 218 generates claim settlement 220 by considering validation exceptions 212, resolution results 215, and preliminary settlement 224. That is, final resolution of claim charge 204 may result in an additional claim advice 222 being sent to client 202.

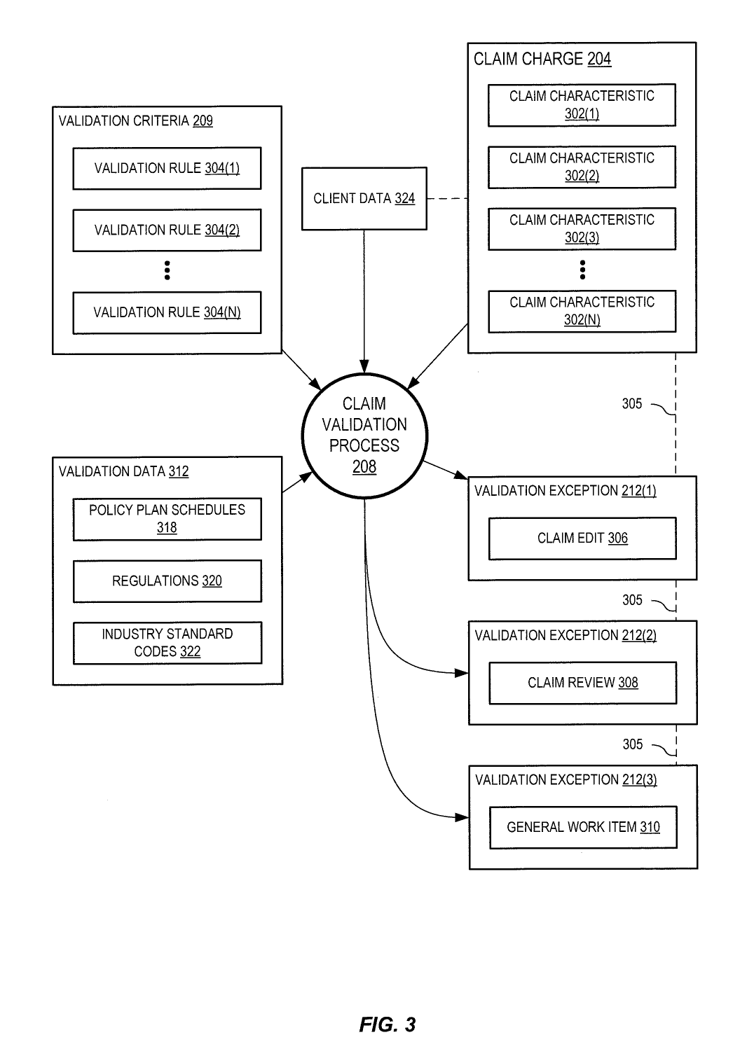

FIG. 3 shows claim validation process 208 of FIG. 2 in further detail. Claim charge 204 is submitted to claim validation process 208, where the claim charge is examined to determine if it has reached validated status 216. Claim charge 204 is shown with a plurality of claim characteristics 302 that are processed by claim validation process 208 against one or more validation rules 304 of validation criteria 209. If one or more validation rules 304 are not met by claim characteristics 302, then claim validation process 208 creates one or more claim validation exceptions 212 that are associated with claim charge 204, as shown by association line 305. In one example of operation, claim validation process 208 may evaluate claim characteristics 302 against validation data 312 based upon one or more validation rules 304. Validation data 312 may include policy plan schedules 318 that include the terms of the policy provided to client 202, regulations 320 that define the regulations imposed upon the policy (e.g., based upon a location of where health care was provided, such as state-based regulations), and industry standard codes 322 that are used to define the policy and claim charge 204. Claim charge 204 is also associated with client data 324 that contains relevant information about client 202, such as address, age, date of birth, for example.

Each claim validation exception 212 may be one of three types: a claim edit 306; a claim review 308; and a general work item 310. For purposes of illustration, FIG. 3 shows one of each of these validation exception types in association with claim charge 204; however, zero, one, or more of each type of claim validation exception 212 may be generated by claim validation process 208 for claim charge 204. If one or more claim validation exceptions 212 are generated by claim validation process 208, a work flow mechanism routes these validation exceptions to exception resolution process 214.

Thus, claim processing according to the present application improves over the conventional methods of “processing the claim,” to an advantageous system of “processing the exceptions.” More specifically, since the present method of claim processing is directed towards resolving identified exceptions, only relevant information associated with generated validation exceptions 212 need be considered, as opposed to the conventional methods where each individual claim is handled as a whole. The significance of this novel method of processing is described in detail below, and is particularly significant regarding resolution of validation exceptions 212, since like exceptions may be grouped and processed concurrently without the complication of having to consider multiple claims individually in their entirety. Furthermore, previously resolved validation exceptions 212 that occur for later claim charges may be automatically resolved based upon earlier resolution results 215.

Claim validation process 208 uses claim charge 204, claim validation criteria 209, client data 324, and validation data 312 during resolution of validation exceptions 212. Validation data 312 includes policy plan schedules 318, regulation 320, and industry standard codes 322, and are defined during require system configuration. Claim validation process 208 determines what exceptions exist within claim charge 204. Each claim review 308 and claim edit 306 may have sub-types that are defined using some of the same data that describes a claim charge, such as industry standard codes 322. Additional criteria may also be included within claim edit 306 and claim review 308, such as one or more of the age of client 202, the gender of client 202, and/or relevant policy criteria.

Policy plan schedules 318 define benefits selected, benefit limitations, benefit categories, current claim accumulators, as well as the list of claim edit types 426 and claim review types 424 that are applicable to client 202. Regulations 320 may be defined by the authority that they represent, such as: company policy; federal government; state government; local government; claim administrator; or risk bearer. Claim validation process 208 uses this data to validate claim charge 204, for example, by matching characteristics 302 of claim charge 204 and/or client data 324 against validation data 312 to generate claim validation exceptions 212, if applicable. Each different claim validation exception 212 represents an autonomous piece of work, and may require the skills of a claim analyst for resolution.

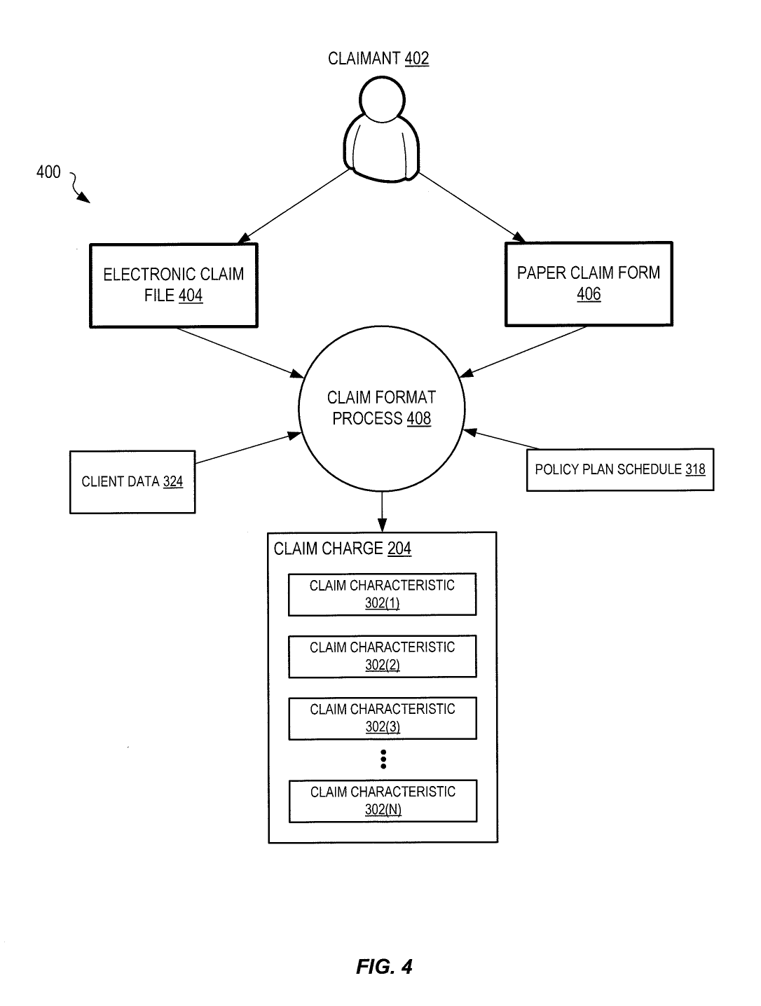

FIG. 4 shows an exemplary sub-system for preparing claim charge 204 from an electronic claim file 404 or a paper claim form 406. Claimant 402 may be an insured person (i.e., the person that has insurance coverage from the insurance company 206 based upon the selected policy plan schedule 318), a physician that has performed healthcare on the insured person, or an institution that has performed healthcare on the insured person. Claimant 402 submits either electronic data file 404 or paper claim form 406 to insurance company 206, where the file/form is processed by a claim format process 408 and converted into standardized claim charge 204 for submission to claim validation process 208. Claim format process 408 may utilize client data 324 and policy plan schedule 318 to prepare claim charge 204. For example, claim format process 408 may include references to client data 324 and policy plan schedule 318 within none, one, or more claim characteristics 302 to facilitate validation and processing of claim charge 204.

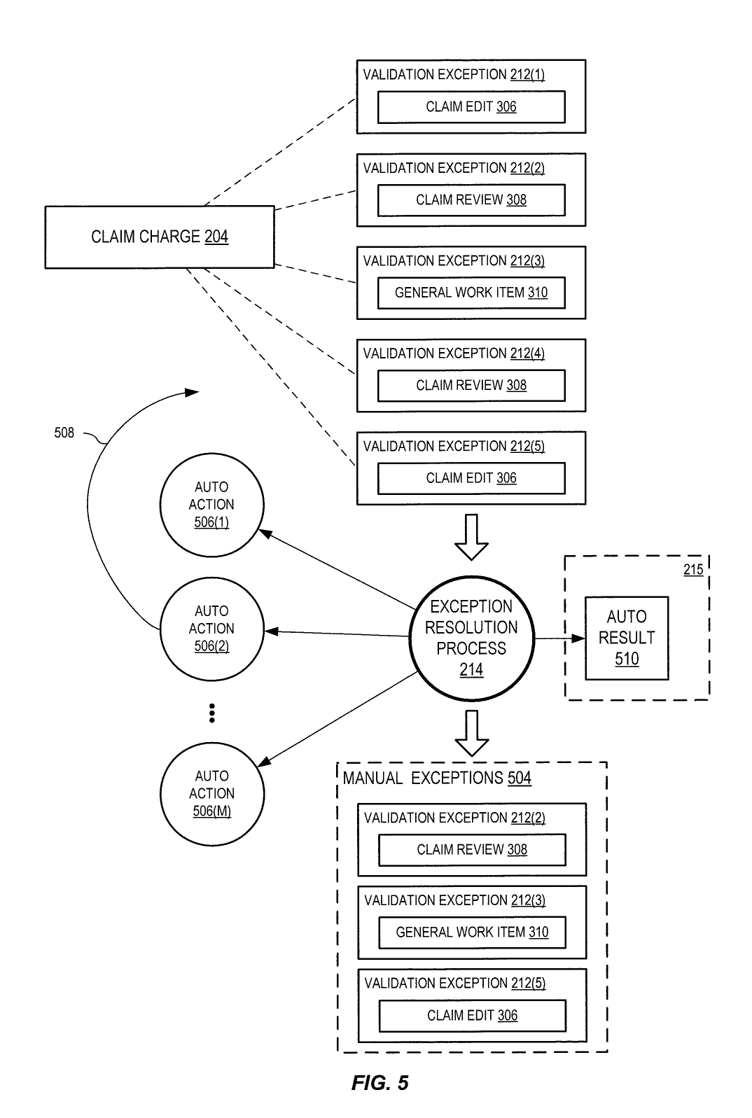

FIG. 5 shows exception resolution process 214 (see FIG. 2) in further detail. In particular, exception resolution process 214 may determine whether a claim analyst should be involved in resolving each claim validation exception 212. For example, only claim validation exceptions 212 that are of type claim review 308 and type claim edit 306 may be eligible for automatic resolution by exception resolution process 214. In this example, claim validation exceptions 212 that are of the type general work item 310 are processed by one or more claim analysts. Each claim validation exception 323 may result in a combination of automated system actions 506 and manual exceptions 504 for processing by a claim analyst. Exception resolution process 214, or a sub-process thereof, processes auto actions 506 to generate one or more auto results 510. In certain circumstances, these automatic actions 506 may result (508) in one or more additional validation exceptions 212 that require resolution.

Exception resolution process 214 determines, for each validation exception, whether the validation exception is a claim review 604 or a claim edit 610, and processes all automatic actions 506 associated therewith. Where the validation exception 212 is a claim review 308, exception resolution process 214 processes all actions of the claim review option that are allowed during the claim validation process. Where the validation exception 212 is a claim edit 306, exception resolution process 214 processes all actions based upon analyst selected result options for the validation exception 212 (i.e., it processes all auto actions 506 that are specified by analysis 608 within edit results 618). Exception resolution process 214 generates one or more auto results 510. Where all validations exceptions 212 are automatically processed for claim charge 204, claim charge 204 may achieve validation status 216. Alternatively, one or more auto actions 506 may result in additional work that requires processing by a claim analyst.

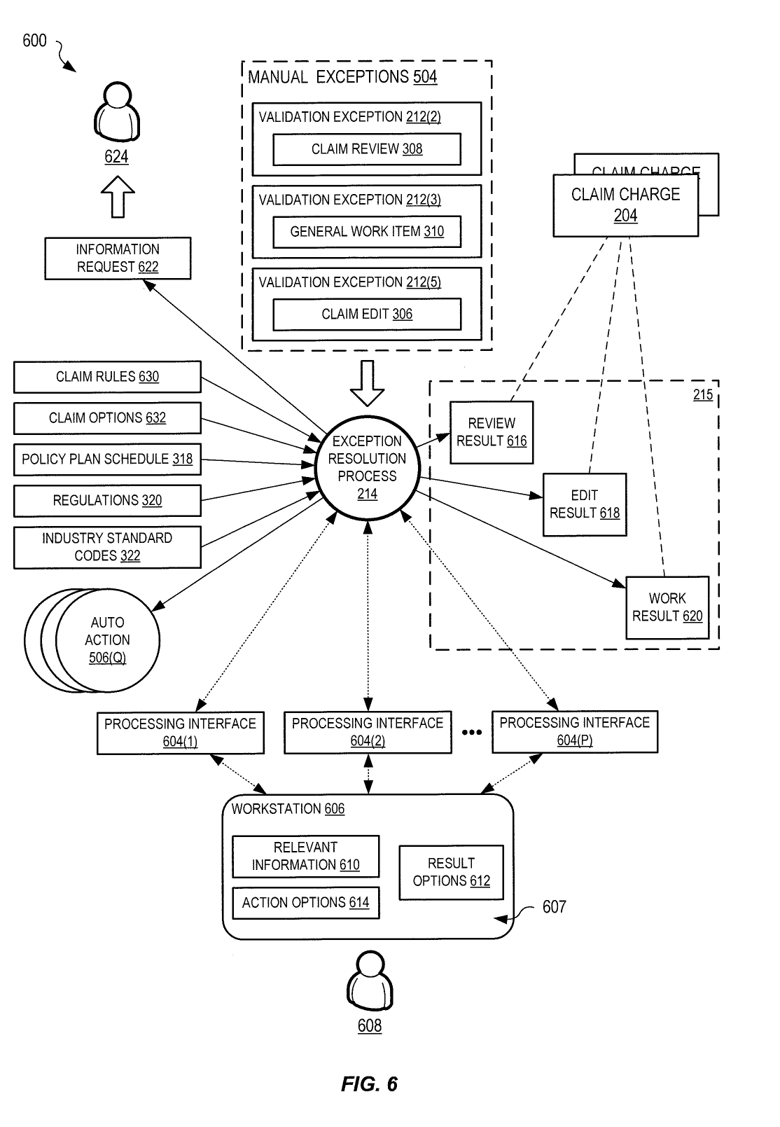

FIG. 6 shows exception validation process 214 interacting with one or more analysts 608 to resolve validation exceptions 212 manually. Each claim validation exception 212 of type claim review 308, claim edit 306, and general work item 310 may be manually processed using an appropriate processing interface 604. Analyst 608 accesses the appropriate interface 604 using a workstation 606, for example. In particular, exception resolution process 214 may select an appropriate processing interface 604 for each validation exception 212 to be processed manually by analyst 608. Although only one analyst 608 is shown, multiple analysts utilizing multiple workstations may interact with exception resolution process 214 to resolve validation exceptions 212, each analyst being presented with the appropriate processing interface 604 for the validation exception 212 to be processed.

Processing of claim review 308 type validation exceptions 212 differs from processing of claim edit 306 type validation exceptions 212 because claim review 308 type validation exceptions 212 may affect multiple claim charges 204, whereas claim edit 306 type validation exceptions 212 may be associated with only one claim charge 204. Multiple claims (e.g., claim 203) may be associated with a claim review (e.g., claim review 308) because selection criteria may be defined for each type of claim review. The selection criteria may include, at least in part, such claim characteristics as: product; form type; claim codes; benefit categories; and insured attributes, such as age. Once system 200 determines that claim charge 204 matches the criteria associated with the type of claim review 308, then claim charge 204 is associated (linked) to claim review 308. A resolution of claim review 308 will affect all associated claim charges 204. The selection criteria may be defined in sub-sets called claim class criteria. If a claim review is organized by claim class criteria, then resolutions (decisions) are performed separately for each class. Claim review 308 type validation exception 212(2) is presented to analyst 608 using processing interface 604(1) and workstation 606. Analyst 608 utilizes workstation 606 to view information 607 presented by processing interface 604(1), thereby viewing relevant information 610, action options 614 and result options 612 that are appropriate for analyst 608 to resolve validation exception 212(2). For example, based upon regulations 320, policy plan schedule 318, claim rules 630, and claim options 632, relevant information 610, action options 614, and result options 612 appropriate for resolution of validation exception 212(2) are presented to analyst 608 such that analyst 608 may determine an appropriate action to resolve validation exception 212(2). That is, each processing interface can be is optimized to deliver the information required to allow analyst 608 to resolve validation exception 212.

When analyst 608 chooses a result option from result options 612, system 200 automatically performs all preconfigured actions, defined within action options 614, for that result option in the review type for the particular claim review. All reference data that defines types of reviews and types of edits can be encapsulated within validation criteria 209 and validation data 213. By selecting one of result options 612 presented by presentation interface 604, analyst 608 may initiate one or more associated predefined actions within action options 614 that may, for example, request additional information. In an example of operation, analyst 608 selects a result option from result options 612 that, based upon associated predefined actions within action options 614, generates an information request 622 that is sent to recipient 624 to request additional information or clarification of existing information. Request recipient 624 may be one or more of a client, such as the insured person, a physician that performed healthcare service for the insured person, or an institution in which the physician performed the healthcare service. Request recipient 624 may also be an external vendor, such as a medical record supplier or a medical specialist used to evaluate the services rendered, as specified by claim charge 204. If analyst 608 has sufficient information to resolve the validation exception 212, then analyst 608 selects the appropriate result from result options 612.

Validation exceptions 212 based on matching criteria (e.g., claim review 308 class criteria of claim review types) are stored as claim review results 215, such as review result 616, edit results 618, and work result 620. Each review has one result, initial or chosen by analyst, for each claim review class (usually, reviews have only one class). Each result determines the one or more actions that will be performed on the claim charges associated with the class. Two significant types of action associated with a result are a denied claim charge and a covered expense claim charge. Review results 616 may apply to multiple claim charges 204, and exception resolution process 214 may also generate, through interaction with analyst 608, one or more automatic actions 506 that are then processed automatically by exception resolution process 214.

Any remaining validation exceptions 212 for claim charge 204 are resolved when all associated claim edits 618 and claim reviews 616 have been resolved (for each, a result option 612 has been chosen by an analyst 608) and all incomplete work results 620 have been completed by an analyst 608, thereby allowing the claim charge to be settled. Where unresolved validation exceptions 212 remain for claim charge 204, claim charge 204 remains open (e.g., waiting additional information or work to be performed).

Claim edit 306 type validation exceptions 212 differ from claim review 308 type validation exceptions 212 because the claim edits only affect a single claim charge. Additionally, claim edit 306 type validation exceptions rarely result in analyst 608 requesting information from external sources. Where analyst 608 has all the information required to resolve the claim edit type 306 validation exception 212 then analyst 608 selects the appropriate result option 612 to generate claim edit result 618. Each claim edit result 618 may have one or more actions (e.g. auto actions 506) that are automatically processed by exception resolution process 214. Where the selected result option 612 resolves all remaining validation exceptions 212 for claim charge 204, claim charge 204 may then reach validated status 216 and is ready for settlement. Alternatively, any validation exception 212 may remain open to wait for additional information or additional work to be performed.

General work item 310 type validation exceptions are normally generated when analyst 608 is required to maintain data that is not readily available through processing interfaces 604 associated with claim edit 306 type and/or claim review 308 type validation exceptions 212. Workstation 606 presents analyst 608 with a processing interface 604 tailored for the type of work of work item 310. Once analyst 608 has manually completed the work, then the workflow work item 310 is marked as completed and the exception 212 has been resolved as work result 620.

Although only one analyst 608 and one workstation 606 are shown in FIG. 6, exception resolution process 214 may support multiple workstations 606 and analysts 608 concurrently.

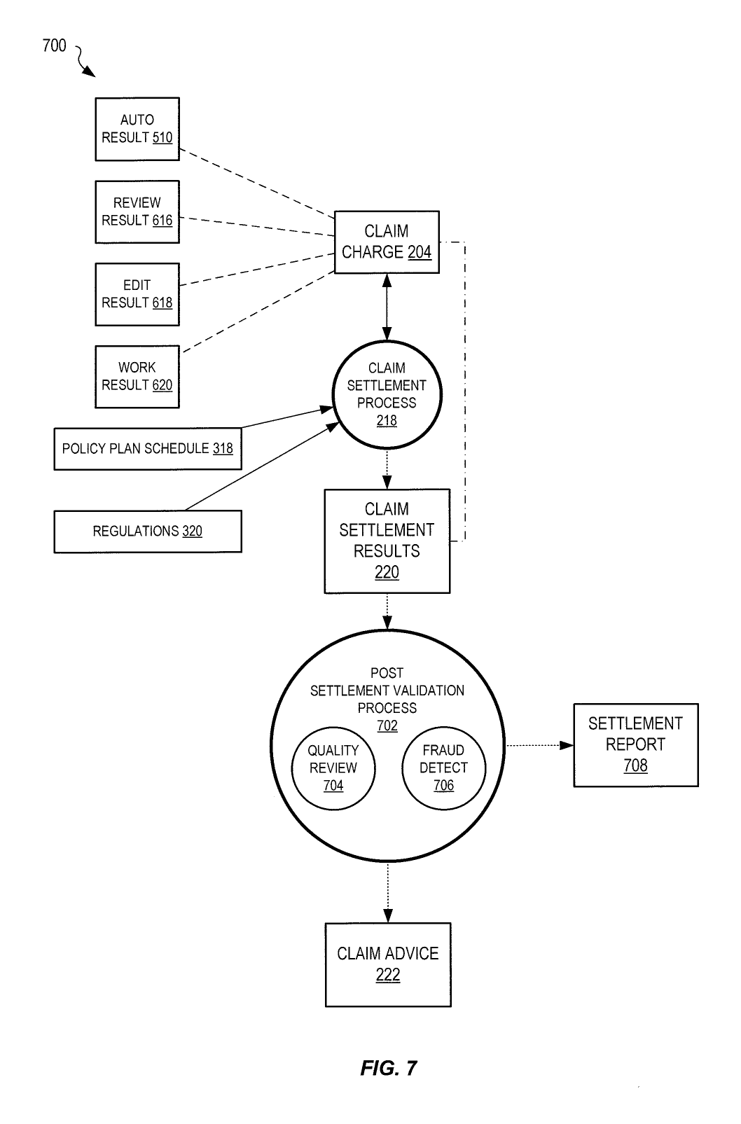

FIG. 7 shows an operation of claim settlement process 218 (see FIG. 2) in further detail. Claim settlement process 218 identifies claim charges 204 that have a validated status 216, but are not settled. As noted above, for a claim charge 204 to have a validated status 216 it must have no unresolved validation exceptions 212. Claim settlement process 218 utilizes the associated policy plan schedule 318, applicable regulations 320, claim edit results 618, claim review results 616, and modifications resulting from general work item results 620 to determine what, if any, benefits are payable to settle claim charge 204 and to produce claim settlement results 220. Claim charge 204 is then updated to indicate that the associated claim (e.g., claim 203) is settled.

Once claim charge 204 is settled, a post settlement validation process 702 may be utilized to identify settlements that require additional validation, such as quality review 704 and/or possible fraud detection 706. Once post settlement validation process 702 completes its review of claim settlement results 220, post settlement validation process 702 may issue claim advice 222 and optionally generate a settlement report 708.

Changes may be made in the above methods and systems without departing from the scope hereof. It should thus be noted that the matter contained in the above description or shown in the accompanying drawings should be interpreted as illustrative, and not in a limiting sense. The following claims are intended to cover generic and specific features described herein, as well as statements of the scope of the present method and system, which, as a matter of language, might be said to fall therebetween.

What is claimed is:

1. A method for health insurance claim processing, comprising:
receiving, within a claim receiver, a claim submission from a client, the claim submission identifying a policy of the client and details of the health insurance claim;
converting, within the claim receiver, the claim submission into a claim charge to facilitate automated processing of the health insurance claim;
validating the claim charge against one or more validation rules to identify zero, one, or more claim validation exceptions;
resolving the claim validation exceptions; and
settling the claim submission based upon the claim charge if the validated claim charge and any remaining validation exceptions conform to settlement control data.

2. The method of claim 1, further comprising issuing a settlement advice based upon the validated claim charge and the settlement control data.

3. The method of claim 1, the step of receiving comprising receiving the claim submission in electronic format from an external submission system.

4. The method of claim 3, wherein the external submission system is a web server, the claim submission being generated online by one of the client and a broker representing the client.

5. The method of claim 1, the step of receiving comprising:
receiving the claim submission in paper format; and
entering data from the paper format claim submission into the claim receiver to form the claim charge.

6. The method of claim 1, the step of determining the claim charge comprising processing the received claim against associated client data and an associated policy plan schedule automatically settles the claim for the claim charge to include claim charge characteristics.

7. The method of claim 1, the step of validating the claim charge further comprising:
identifying claim validation exceptions that require no analyst intervention; and
automatically processing the identified claim validation exceptions.

8. The method of claim 1, the step of validating the claim charge comprising automatically identifying one or more claim validation exceptions that require handling by an analyst.

9. The method of claim 8, the step of resolving the claim validation exceptions further comprising:
presenting each of the one or more claim validation exceptions to the analyst, the analyst selecting an option result; and
performing one or more associated actions to resolve the validation exception.

10. The method of claim 9, the step of presenting comprising presenting two or more of the one or more claim validation exceptions to two or more analysts concurrently, the analysts each determining one or more actions to be taken to resolve each of the presented validation exceptions.

11. A software product comprising instructions, stored on a non-transient computer-readable medium, wherein the instructions, when executed by a computer, perform steps for health insurance claim processing, comprising the steps of:
receiving a claim;
converting the claim to a claim charge;
validating the claim charge to identify claim validation exceptions;
resolving the claim validation exceptions; and
settling the claim.

12. A health insurance claim processing system, the system including a database for storing tables and procedures, wherein the procedures comprise machine readable instructions for providing:
a claim format process for processing a claim submission received from a client into a claim charge;
a claim validation process for validating the claim charge and generating zero, one or more validation exceptions;
an exception resolution process for resolving the one or more validation exceptions; and
a claim settlement process for settling the claim charge once all validation exceptions, if any, are resolved.

13. A health insurance claim processing method, comprising the steps of:
formatting a plurality of claim submissions into a plurality of claim charges stored in an electronic database;
determining at least one validation exception for each of the plurality of claim charges;
grouping the at least one validation exception for each of the plurality of claim charges together with other validation exceptions of the same type from different ones of the plurality of claim charges to form a group of validation exceptions within the database;
processing the group of validation exceptions together; and
updating each of the plurality of claim charges with a respective processed validation exception.
